(19) United States
(12) Patent Application Publication
(10) Pub. No.: US 2008/0266601 A1
(43) Pub. Date: Oct. 30, 2008

(54) INFORMATION PROCESSING APPARATUS AND JOB MANAGEMENT METHOD

(75) Inventors: Tomoko Narukawa, Kawasaki-shi (JP); Hiroyuki Kayama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/109,575

(22) Filed: Apr. 25, 2008

(30) Foreign Application Priority Data
Apr. 27, 2007 (JP) 2007-119030

(51) Int. Cl. G06K 15/00

(52) U.S. Cl. 358/1.15

(57) ABSTRACT

An information processing apparatus capable of storing a job transmitted to a printing apparatus includes an obtaining unit configured to obtain a job result regarding the job from the printing apparatus, an identifying unit configured to identify an output mode of the job, a reference unit configured to store a storage setting that defines whether to store or delete job data based on a combination of the job output mode and the job result and reference the storage setting, based on the output mode identified by the identifying unit and the job result obtained by the obtaining unit, and a storage control unit configured to store or delete the transmitted job based on the storage setting referenced by the reference unit.

### BACKGROUND OF THE INVENTION

1. Field of the Invention

The present invention relates to a printing job technique for outputting a printing job from a printing apparatus.

2. Description of the Related Art

A reprinting technique for saving a job transmitted to a printing apparatus on a client PC and after a while, retransmitting the job to the printing apparatus to prompt the apparatus to execute the job has been known. For example, Japanese Patent Application Laid-Open No. 2006-228011 discusses a reprinting method that saves a printing job in a hard disk of a printing apparatus in case of reprinting and after a while, instructs the printing apparatus to reprint the saved printing.

Japanese Patent Application Laid-Open No. 2006-228011 discusses a technique for saving a plurality of jobs in a hard disk in a printing apparatus and after a while, sending a reprinting instruction to a printing job selected by a user.

Furthermore, Japanese Patent Application Laid-Open No. 11-305976 discusses a technique for manually deleting unnecessary job data to prevent the total number of jobs saved on a client PC from increasing and to save a larger amount of job data with efficiency.

In saving job data on a client PC, if all the job data is saved, job data that is supposed not to be reprinted is also saved, so that increased data amount hinders the PC from storing necessary job data. Moreover, if the total number of job data increases, it takes time to find a job as a reprinting target. It also takes time for a user to determine the necessity of individual job data and manually delete unnecessary ones.

### SUMMARY OF THE INVENTION

According to an aspect of the present invention, an information processing apparatus capable of storing a job transmitted to a printing apparatus includes an obtaining unit configured to obtain a job result regarding the job from the printing apparatus, an identifying unit configured to identify an output mode of the job, a reference unit configured to store a storage setting that defines whether to store or delete job data based on a combination of the job output mode and the job result and reference the storage setting, based on the output mode identified by the identifying unit and the job result obtained by the receiving unit, and a storage control unit configured to store or delete the transmitted job based on the storage setting referenced by the reference unit.

An exemplary embodiment of the present invention enables storage control of job data according to user settings based on a job output mode and a job result. Hence, a user can store much more necessary jobs without manually deleting unnecessary data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration example of an information processing system according to an exemplary embodiment of the present invention.

FIG. 2 is a block diagram illustrating the configuration of the information processing apparatus of FIG. 1.

FIG. 3 illustrates an example of a memory map of a random access memory (RAM) of FIG. 2.

FIG. 4 illustrates an example of a memory map of a floppy disk (FD) of FIG. 2.

FIG. 5 illustrates a relationship between an FD drive and an FD inserted to the FD drive of FIG. 2.

FIG. 6 illustrates a configuration example of a printing control program according to an exemplary embodiment of the present invention.

FIG. 7 illustrates information in a job data storage unit, a job management unit, and a storage control unit of FIG. 6.

FIG. 8 illustrates an example of job execution information in job management unit of FIG. 7 according to a first exemplary embodiment of the present invention.

FIG. 9 illustrates an example of job setting information in a job data storage unit of FIG. 7.

FIGS. 10A and 10B illustrates an example of condition definition information and condition-specific storage setting information in storage control unit of FIG. 7.

FIG. 11 illustrates an example of job end notification sent to an information processing apparatus from a printing apparatus.

FIG. 12 is a flowchart illustrating a processing flow according to the first exemplary embodiment of the present invention.

FIG. 13 is a flowchart illustrating a processing flow of job monitoring processing in step S1206 of FIG. 12.

FIG. 14 is a flowchart illustrating a processing flow of storage control processing in step S1207 of FIG. 12.

FIG. 15 is a flowchart illustrating a processing flow of storage condition reference processing in step S1402 of FIG. 12.

FIG. 16 illustrates an example user interface (UI) used for condition-specific storage settings.

FIG. 17 illustrates an example of job execution information according to a second exemplary embodiment of the present invention.

FIG. 18 is a flowchart illustrating a processing flow of storage control processing in step S1207 according to the second exemplary embodiment of the present invention.

FIG. 19 illustrates an example screen for inputting a new job which enables designation of job-based storage settings.

### DETAILED DESCRIPTION OF THE EMBODIMENTS

Various exemplary embodiments, features, and aspects of the invention will be described in detail below with reference to the drawings.

### First Exemplary Embodiment

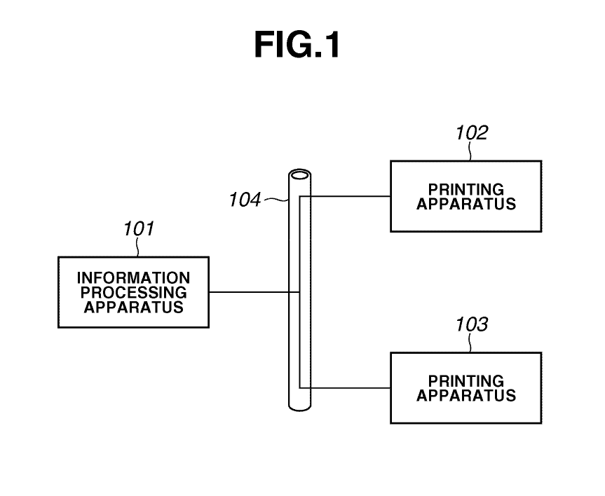

FIG. 1 is a block diagram illustrating the configuration of an information processing system according to an exemplary embodiment of the present invention. In FIG. 1, an information processing apparatus 101 is connected to a network 104 via a network cable. The information processing apparatus 101 is communicable with printing apparatuses 102 and 103 as external devices as described below. The information processing apparatus 101 manages a plurality of printing apparatuses connected to the network 104.

The information processing apparatus 101 is a general information processing apparatus and stores a printing control program in an executable manner. Further, the information processing apparatus 101 of the present exemplary embodiment has functions of transmitting a printing job including print data requested to be printed toward the printing apparatuses 102 and 103 and acquiring and sending various kinds of information about jobs and statuses of the printing apparatuses 102 and 103.

The printing apparatuses 102 and 103 are connected to the network 104 via a network cable. The printing apparatuses 102 and 103 analyze a printing job including print data sent from the information processing apparatus 101 and convert the job into dot images on a page-by-page basis to print the images of each page. Further, the printing apparatuses 102 and 103 can provide a job management function defined in the ISO10175 (document printing application (DPA)) to the information processing apparatus 101.

In addition, all or a part of functions executed by the information processing apparatus 101 can be installed to the printing apparatuses 102 and 103 or a network interface card thereof. The network 104 is connected to the information processing apparatus 101, and the printing apparatuses 102 and 103. The network 104 can be either wired or wireless.

FIG. 1 illustrates only one information processing apparatus 101. In practice, however, a plurality of information processing apparatuses can be connected. The total number of printing apparatuses 102 and 103 is not limited to two and one or more printing apparatuses can be connected in practice. Moreover, as the printing apparatuses 102 and 103, various types of printing apparatuses such as an electrophotographic laser beam printer and an inkjet printer can be employed.

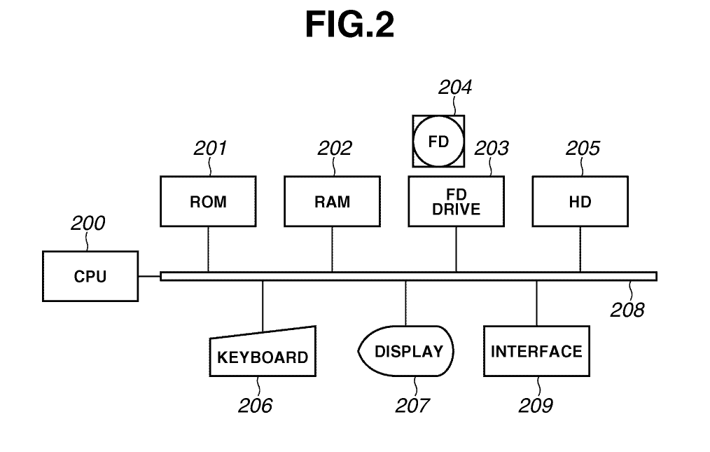

FIG. 2 is a block diagram illustrating hardware configuration of the information processing apparatus 101 of FIG. 1. A central processing unit (CPU) 200 is a control unit which executes application programs, a printer driver program, an operating system (OS), and a printing control program stored in a hard disk (HD) 205. In addition, the CPU 200 performs control to temporarily store files and information necessary to execute programs in a random access memory (RAM) 202 as described below.

A read only memory (ROM) 201 is a storage unit, which stores programs such as a basic input/output (I/O) program, and various data such as font data and template data used upon document management. The RAM 202 is a temporary storage unit, which functions as a main memory and a work area of the CPU 200.

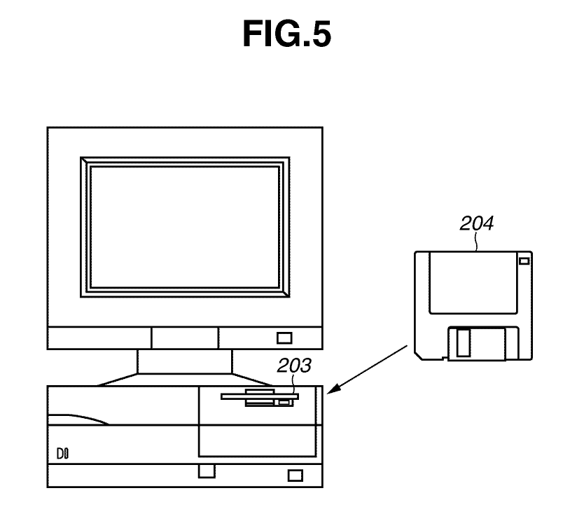

A floppy disk (FD) drive 203 is a storage medium read unit which can download programs stored in a floppy disk (FD) 204 to the computer system as described below with reference to FIG. 5. The storage medium is not limited to the FD but may be a compact disk read only memory (CD-ROM), a compact disk recordable (CD-R), a compact disk rewritable (CD-RW), a personal computer (PC) card, a digital versatile disk (DVD), an integrated circuit (IC) memory card, a magnetooptic disk (MO), a memory stick, or the like.

The FD 204 is a storage medium that stores computer-readable programs. The HD 205 is a kind of external storage unit which functions as a large-capacity memory and stores an application program, a printer driver program, an OS, a printing control program, and a related program. Further, the HD 205 stores a spooler as a spool unit. The spool unit refers to a client spooler on a client side and a server spooler on a printer server side.

A keyboard 206 is an instruction input unit which allows a user to input commands such as a device control command to the information processing apparatus 101.

A display 207 is a display unit which displays commands input with the keyboard 206 and a job status, for example, the status received from the printing apparatuses 102 and 103. A system bus 208 controls a data flow in the information processing apparatus 101. An interface 209 is an input/output unit. The information processing apparatus 101 exchanges data with an external device via the interface 209.

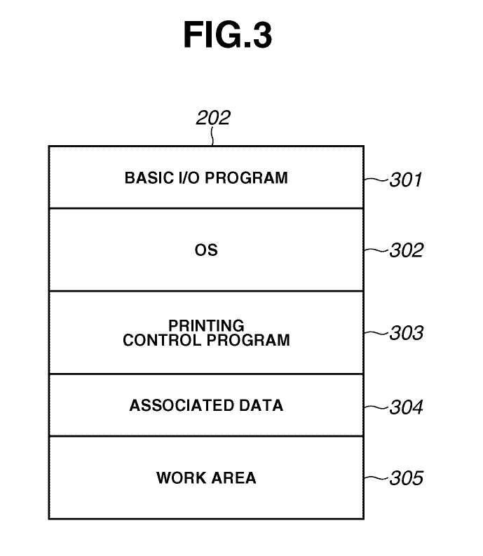

FIG. 3 illustrates an example of a memory map of the RAM 202 illustrated in FIG. 2. This memory map is obtained when the printing control program loaded from the FD 204 is downloaded to the RAM 202 and ready to execute.

In the present exemplary embodiment, a printing control program and associated data are directly loaded from the FD 204 to the RAM 202 and executed. Instead of this operation, each time a printing control program in the FD 204 is executed, the HD 205 can load the preinstalled printing control program to the RAM 202. Further, the printing control program can be stored in mediums other than the FD, such as a CD-ROM, a CD-R, a PC card, a DVD, and an IC memory card.

Moreover, the printing control program can be stored in the ROM 201 to configure a part of the memory map and directly executed by the CPU 200. Furthermore, software having functions equivalent to the above devices can constitute a substitute for a hardware device.

The printing control program includes a program for instructing to change an output destination of a printing job or change a print order on the client side. The printing control program further includes a program for controlling a processing order of printing jobs or notifying the apparatus of a result of the printing job or a request to change the output destination of the print job in the printer server. Further, the printing control program of the present exemplary embodiment which executes the above control can be divided into a module installed to the client side and a module installed to the printer server side.

Alternatively, one printing control program can selectively serve for the client or the printer service depending on an execution environment. Further, a module having a function directed to the client and a module having a function directed to the printer server can be both installed to one computer, and operated at the same time or in parallel in a pseudo time-sharing manner.

A basic I/O program 301 corresponds to an area storing a program having an initial program loading (IPL) function which starts an operation of an OS that is loaded from the HD 205 to the RAM 202 when the control device is powered on. An operating system (OS) 302 and a printing control program 303 are stored in allocated areas of the RAM 202. Associated data 304 is stored in any allocated area of the RAM 202. A work area 305 is reserved as a work area for the CPU 200 to execute, for example, the printing control program 303 of the present exemplary embodiment.

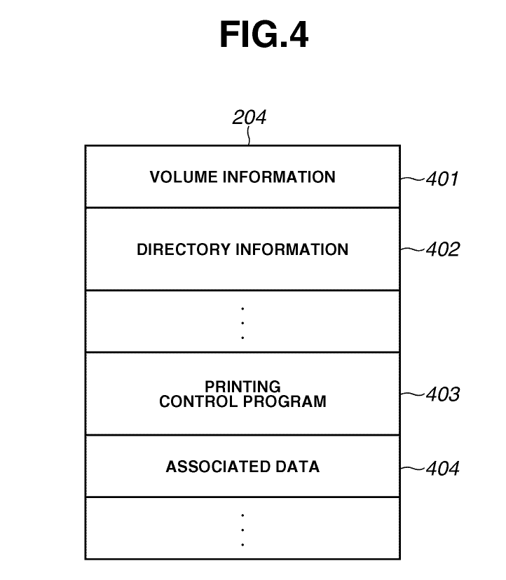

FIG. 4 illustrates an example of a memory map of the FD 204 of FIG. 2. FIG. 4 illustrates volume information 401 as information about data, directory information 402, a printing control program 403 described in the present exemplary embodiment, and associated data 404 thereof. The printing control program 403 is generated based on flowcharts of the exemplary embodiments. In the present exemplary embodiment, the same program configuration is applied to the client and the server.

FIG. 5 illustrates a relationship between the FD drive 203 of FIG. 2 and the FD 204 inserted to the FD drive 203 with same reference numerals of FIG. 2. The FD 204 stores the printing control program of the present exemplary embodiment and its associated data.

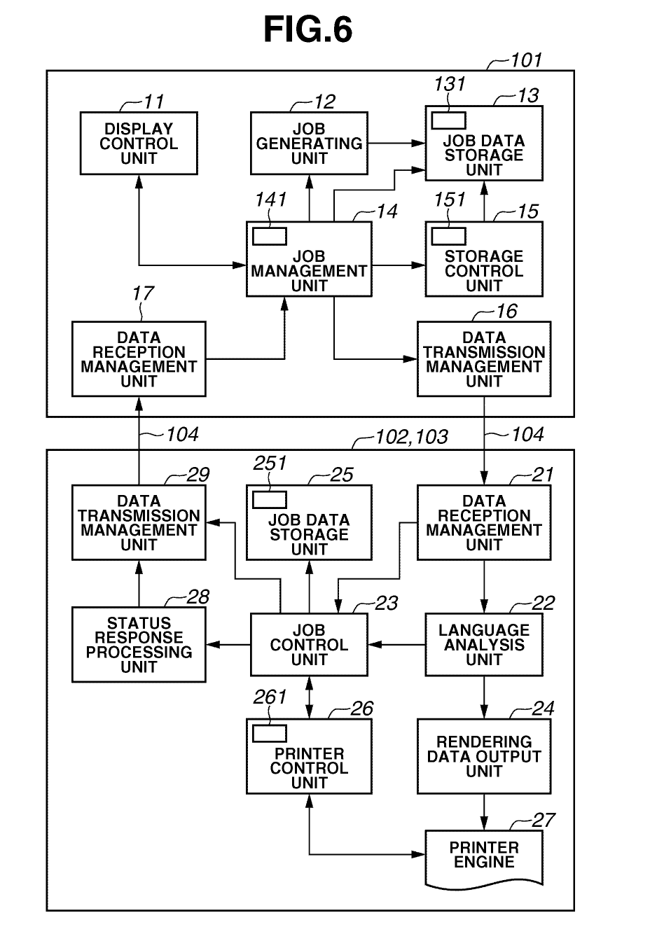

FIG. 6 is a block diagram illustrating a software function of the printing control system of the present exemplary embodiment. In FIG. 6, the information processing apparatus 101 is physically or logically connected to the printing apparatuses 102 and 103 via a communication cable that enables bidirectional communication, directly or indirectly via a network such as the Internet or Intranet. The components 101 to 104 of FIG. 6 are identical to those of FIG. 1. Hereinafter, a network computer side and the printing apparatus side are separately described in order.

In the information processing apparatus 101, a display control unit 11 displays information sent from the printing apparatuses 102 and 103 on a display or receives job settings and a job execution command input by a user. Further, the display control unit 11 displays a job processing result on the display.

A job generating unit 12 converts job data into a format suitable for the printing apparatus from a document format such as word processor or spreadsheet document format according to a job generation command from a job management unit 14. In addition, the job generating unit 12 transfers job data to a data transmission management unit 16. A job data storage unit 13 stores the job data generated by the job generating unit 12.

The job data storage unit 13 stores job data generated by the job generating unit 12 and job setting information 702 regarding preset values of job attributes. When a request to acquire job setting information from the job management unit 14 is received, the job data storage unit 13 sends back the job setting information 702. A job data memory 131 stores job data generated by the job generating unit 12 and the job setting information 702. The job setting information 702 includes a plurality of job attributes and is managed on a job-by-job basis. The job setting information 702 is generated and deleted in sync with the job data generation and deletion.

The job management unit 14 obtains the job setting information or job end notification regarding jobs in the printing apparatuses 102 and 103 via a data transmission management unit 16 and a data reception management unit 17. Further, the job management unit 14 issues a job manipulation command to execute/stop/cancel jobs in the printing apparatuses 102 and 103, and a job result inquiry command.

Moreover, the job management unit 14 can obtain job information from the job data storage unit 13. Jobs stored in a job data storage unit 25 of the printing apparatuses 102 and 103 or the job data storage unit 13 of the information processing apparatus 101 can be executed to perform reprinting according to a reprinting command sent from the job management unit 14.

A job execution information memory 141 stores job execution information 701 including a job data ID, a job name, a user name, an output mode, and an executed job ID regarding a job as a target of a printing command. When a job end notification is received from the printing apparatuses 102 and 103, the job management unit 14 notifies the storage control unit 15 of a job data ID and a job result.

The job end notification sent from the printing apparatuses 102 and 103 includes an executed job ID and a job result. Further, if a job on a list of the job execution information 701 which is expected to be being executed is not included in a list of executed jobs in the printing apparatus, the job management unit 14 determines that the job is completed and inquires a job result of the printing apparatus.

The storage control unit 15 has the following function. When the job management unit 14 receives the job end notification from the printing apparatuses 102 and 103, the storage control unit 15 receives the job data ID and the job result from the job management unit 14. A storage setting information memory 151 stores storage setting information for each condition based on a job output mode and the job result. The job storage control unit 15 specifies an output mode from the job setting information 702 of a target job based on the job data ID received from the job management unit 14.

The storage control unit 15 determines which of the conditions defined in condition definition information 704 corresponds to the target job based on the specified output mode and the job result received from the job management unit 14. The storage control unit 15 references storage settings of the corresponding condition in condition-specific storage setting information 703, and deletes or saves job data according to the storage settings.

The data transmission management unit 16 has the following function. The job management unit 14 inputs a job or sends a job manipulation command, a job setting information acquisition command, and a job result inquiry command via the data transmission management unit 16 to the printing apparatuses 102 and 103.

The data reception management unit 17 has the following function. The job management unit 14 receives a reply to the job setting information acquisition command and the job manipulation command via the data reception management unit 17 from the printing apparatuses 102 and 103.

Any or all components on the information processing apparatus 101 or their functions are not necessarily provided in a host computer. If these components and functions are provided in the printing apparatuses 102 and 103 or a server computer and other computers, the present invention can be applied without departing from the scope of the invention.

In the printing apparatuses 102 and 103, a data reception management unit 21 receives job data, a job manipulation command, and a job setting information acquisition command input from the information processing apparatus 101.

A language analysis unit 22 analyzes job data in detail and executes a control command regarding job management and rendering data output according to the job setting. The language analysis unit 22 receives command groups one by one from the data reception management unit 21, and determines what processing is required by the received command according to the description rule of a printer control language.

If the determination result shows that the target command is a command regarding job manipulation such as a command to start or terminate a job, or a job attribute such as a sheet size, the number of copies, and the necessity of stapling operations, the language analysis unit 22 issues a corresponding job control command to a job control unit 23. If the command is an instruction to render characters, figures or images, the language analysis unit 22 sends to a rendering data output unit 24 a corresponding command to output rendering data.

The job control unit 23 controls and schedules jobs sent from the information processing apparatus 101 on a job-by-job basis according to the job control command from the language analysis unit 22. When a job start command is received, the job control unit 23 stores job data in the job data storage unit 25. The job data is generated in response to the job start command and confirmed in response to a job termination command.

The jobs stored in the job data storage unit 25 can be reprinted according to instructions from the information processing apparatus 101 irrespective of whether the job termination command is received. Further, the job control unit 23 can change the job attributes and scheduling priorities (printing-order), and cancel printing (delete job data).

The job control unit 23 instructs a printer control unit 26 to select a desired sheet and discharge bin based on job attributes, and obtains a status of the printing apparatus via the printer control unit 26 to continuously monitor the status of the job being executed. If any error occurs, for example, the job control unit 23 generates a notification status as necessary. If a reprinting command is received from the information processing apparatus 101, the job control unit 23 acquires job data from the job data storage unit 25 to execute reprinting of the job.

The job data storage unit 25 stores job data, and the job setting information 702 about a job stored in the job data storage unit 25. A job data memory 251 stores job data and the job setting information 702. When a job information acquisition command is received from the information processing apparatus 101, the job data storage unit 25 sends back the job setting information 702. Moreover, if a reprinting command is received from the job control unit 23, the job data storage unit 25 can execute reprinting of applicable job data.

The rendering data output unit 24 rasterizes rendering data such as characters, figures, and images and outputs the data to a printer. The rendering data output unit 24 generates character patterns, performs graphic computation or rasterization of image data according to a rendering data output command from the language analysis unit 22, and rasterizes the data to an output data format to thereby send the resultant data to a printer engine 27.

The printer engine 27 is, for example, a laser beam printer engine which executes actual printing operations using an electrophotographic process or the like according to rasterized data output from the rendering data output unit 24. Further, the printer engine 27 includes a remaining recording sheet detecting unit. If no sheet is set on the printer, the printer engine 27 keeps sending a warning signal to the printer control unit 26 as described below. If no sheet is set in rasterization/printing processing, the printer engine 27 stops a recording unit, for example, a printer drum and sends an error message to the printer control unit 26 using an interrupt unit or the like.

The printer control unit 26 selects a desired sheet or executes control of the printer such as initialization in response to a printer control command from the job control unit 23. Further, the printer control unit 26 keeps monitoring overall condition of the printer such as the condition of a sheet cassette, whether a door is opened/closed, or shortage of toner, and notifies the other components of the printer state if necessary. The latest printer state information such as the number of remaining sheets or an error is stored in a printer information management memory 261 of the printer control unit 26.

A status response processing unit 28 has the following function. In response to a status response request command from the job control unit 23, the status response processing unit 28 converts a status notification described in the internal format of the printer to an external format applicable to the information processing apparatus 101 to generate status response information. Then, the status response processing unit 28 sends the result to a data transmission management unit 29.

When the status response information is received from the status response processing unit 28, the data transmission management unit 29 temporarily stores the information in a transmission buffer or the like and then sends the information to the information processing apparatus 101 via a communication unit 104.

If any or all components on the printing apparatuses 102 and 103 or their functions are provided in a host computer, a server computer and other computers, the present invention can be applied without departing from the scope of the invention.

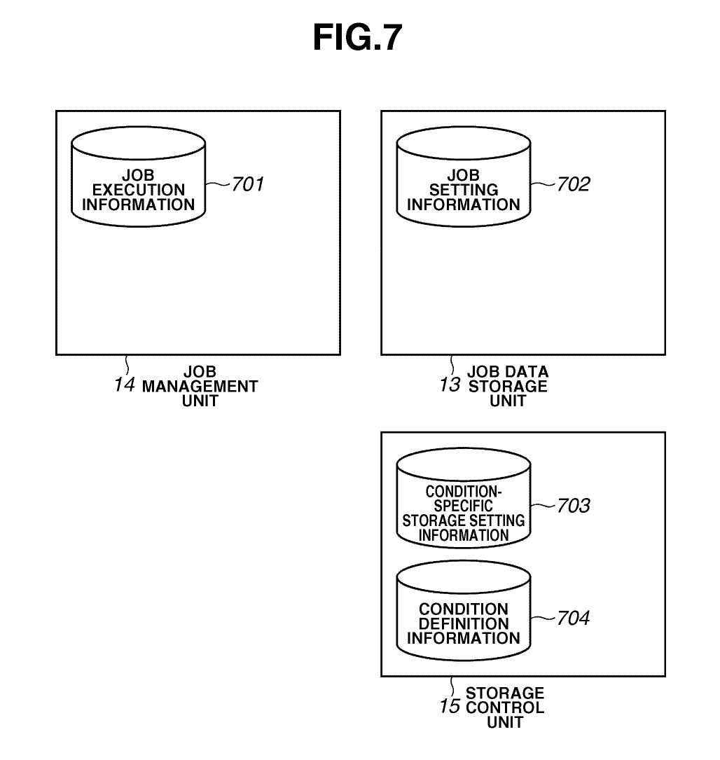

FIG. 7 illustrates layout of the job execution information 701, the job setting information 702, the condition-specific storage setting information 703, and the condition definition information 704.

The job execution information 701 is stored in the job management unit 14. The job execution information 701 is information about a job which is input to the printing apparatus and data of which is not stored yet. The job management unit 14 sends a job generation command to the job generating unit 12, and transmits the generated job data to the printing apparatus. The job management unit 14 generates the job execution information 701 upon sending the job generation command. The job execution information 701 includes a job data ID and an executed job ID. The executed job ID identifies jobs being executed in the printing apparatus. After the transmission of the job data, IDs of jobs received from the printing apparatuses 102 and 103 are recorded.

The job setting information 702 is stored in the job data storage unit 13. When a job data generation command is received from the job generating unit 12, the job data storage unit 13 generates job data and stores the generated job data in the job data memory 131.

The job data storage unit 13 generates the job setting information 702 as well as the job data and stores the generated job setting information. If a job data deletion command is received from the job management unit 14 or the storage control unit 15, the job data storage unit 13 deletes job data and the job setting information 702 of a target job. The job setting information 702 includes a job data ID and a plurality of job attributes such as a user name, a job name, and an output mode.

The condition-specific storage setting information 703 is stored in the job storage control unit 15. The condition-specific storage setting information 703 includes predefined conditions and storage settings corresponding to each condition. If a job result and data about an output mode is received from the job management unit 14, the job storage control unit 15 selects a corresponding condition based on the job result and the output mode.

Then, the job storage control unit 15 references storage setting corresponding to the condition. If the storage setting is set “OFF”, the job storage control unit 15 sends a command to delete a corresponding job to the job data storage unit 13. If the storage setting is set “ON”, the job data storage unit 13 stores the corresponding job.

The condition definition information 704 defines a combination of a job result and an output mode. The condition-specific storage setting information 703 includes storage settings corresponding to each condition defined by the condition definition information 704.

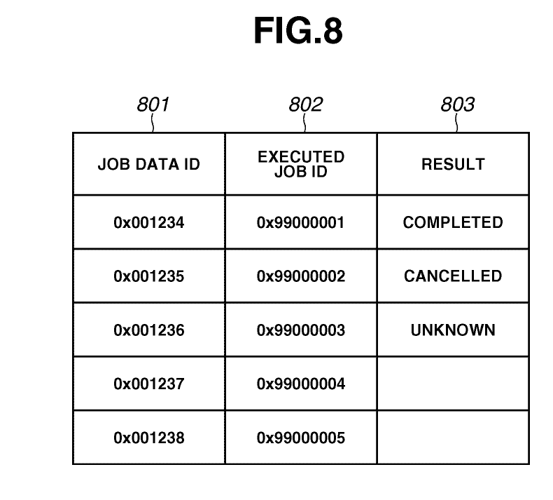

FIG. 8 illustrates an example of a job execution information list of the job management unit 14. The job execution information 701 includes a job data ID 801, an executed job ID 802, and a job result 803. The job execution information 701 is generated when the job management unit 14 issues a job generation command.

The job data ID 801 is an identifier of job data stored in the job data storage unit 13. When the job management unit 14 sends generated job data to the printing apparatuses 102 and 103, the printing apparatus receives the job data and sends back an executed job ID. The job management unit 14 records the ID received from the printing apparatus in the executed job ID 802. Further, the job management unit 14 records a job result from the printing apparatus as the job result 803.

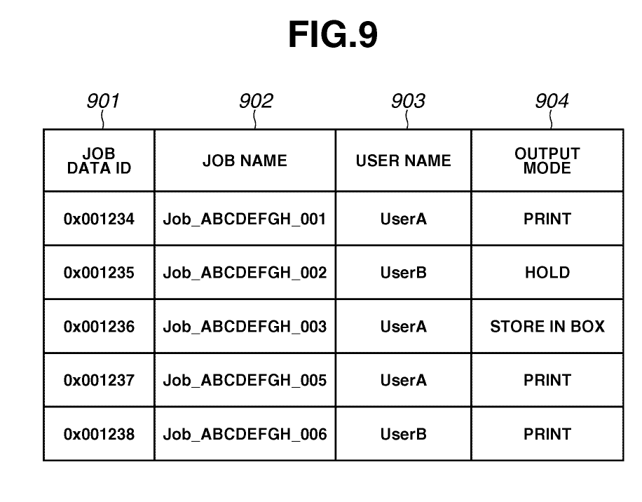

FIG. 9 illustrates an example of a list of job setting information 702 stored in the job data storage unit 13. The setting information regarding job data stored in the job data storage unit 13 is recorded as the job setting information 702 in the same job data storage unit 13. The job management unit 14 and the storage control unit 15 reference the job setting information 702.

In the illustrated example of FIG. 9, the job setting information 702 includes a job data ID 901, and three job attributes (a job name 902, a user name 903, and an output mode 904). The job name 902 and the user name 903 are character strings that a user can arbitrarily determine. As for the output mode 904, one of “print”, “hold”, and “store in box” is selected.

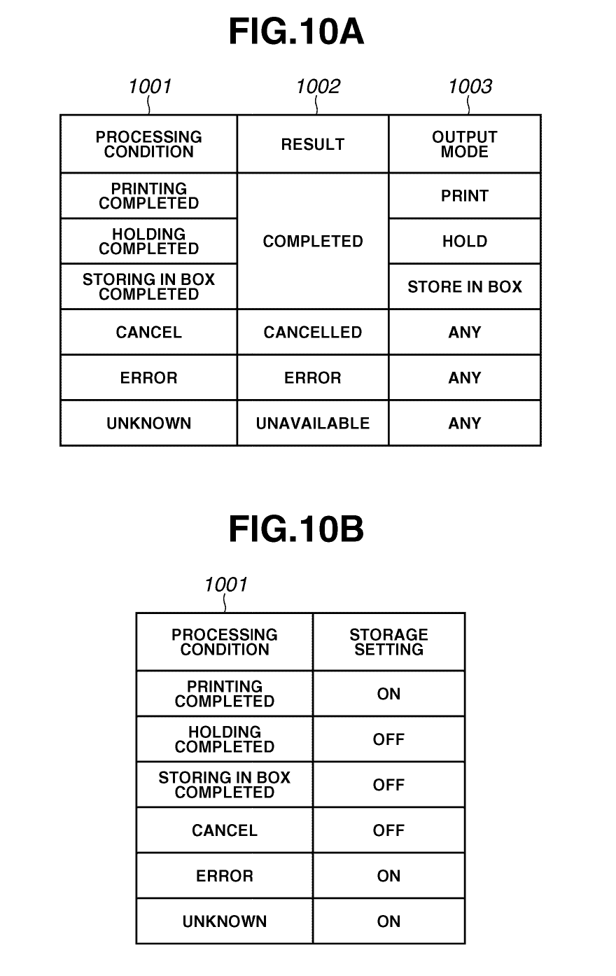

FIG. 10A illustrates an example of the condition definition information 704 stored in the storage control unit 15. The condition definition information 704 is definition information regarding a condition 1001 of the condition-specific storage setting information 703. The condition 1001 is defined based on a combination of a job result 1002 and an output mode 1003 and includes “printing completed”, “holding completed”, “storing in box completed”, “cancelled”, “error”, and “unknown”.

In the illustrated example of FIG. 10A, an output mode “ANY” indicates that an output mode is any of “print”, “hold”, and “store in box” without any limitations. In FIG. 10A, a job result “unavailable” indicates that a job result cannot be received from the printing apparatus (the job result is uncertain).

FIG. 10B illustrates an example of the condition-specific storage setting information 703 stored in the storage control unit 15. The condition 1001 is defined in FIG. 10B. The storage setting 1003 is set to “ON” or “OFF”. If the setting is “ON”, the storage control unit 15 stores the job data. If the setting is “OFF”, the storage control unit 15 deletes the job data.

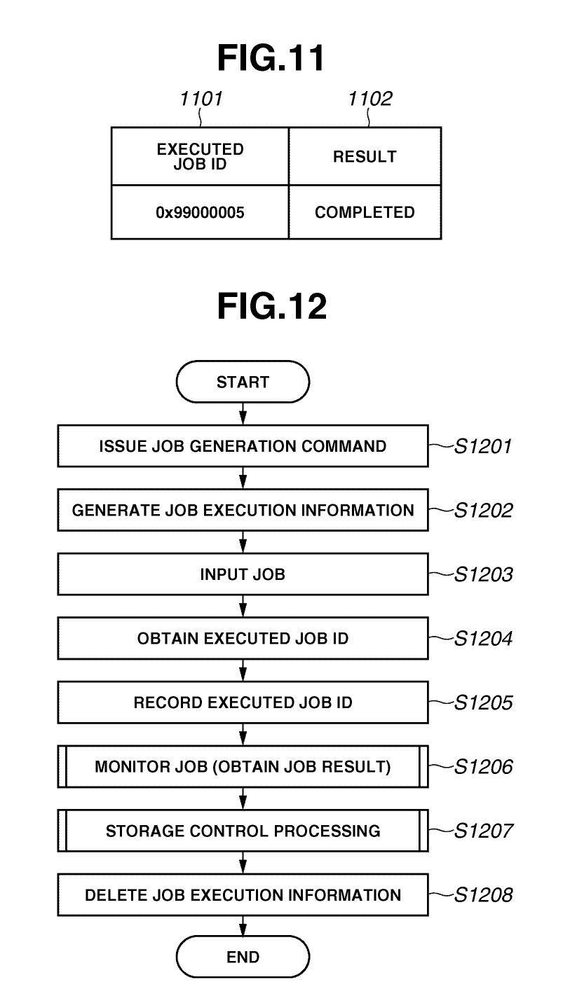

FIG. 11 illustrates an example of a job end notification which is sent from the printing apparatuses 102 and 103 to the information processing apparatus 101 when a job is completed. The job end notification includes an executed job ID 1101 and a job result 1102. The job result 1102 includes “completed”, “error”, and “cancelled”.

Referring to a flowchart of FIG. 12, the first exemplary embodiment of the present invention will be described below. First, in step S1201, the job management unit 14 sends a job generation command to the job generating unit 12. In step S1202, the job management unit 14 generates the job execution information 701. In step S1203, the job management unit 14 inputs the job generated in step S1201 to the printing apparatus.

In step S1204, the job management unit 14 receives a job transmission end notification from the printing apparatus and obtains an executed job ID. In step S1205, the job management unit 14 records the executed job ID received from the printing apparatus in the job execution information 701. In step S1206, the job management unit 14 monitors the job. The job monitoring processing in step S1206 is described in detail below.

In step S1207, the job management unit 14 issues a command to execute storage to the storage control unit 15. The storage control processing in step S1207 is described below in detail. In step S1208, the job management unit 14 deletes the job execution information 701 generated in step S1202.

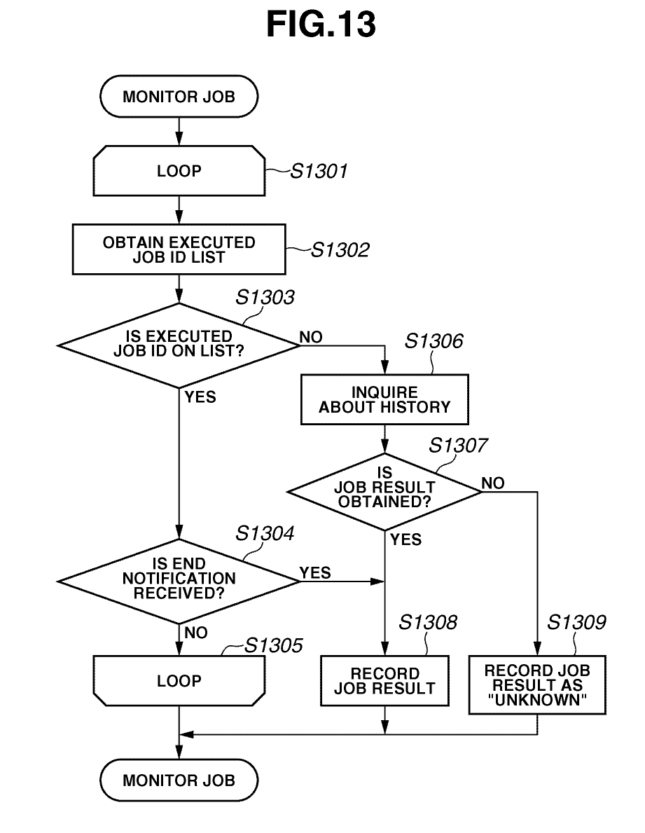

The job monitoring processing in step S1206 is described in detail with reference to a flowchart of FIG. 13. In a loop from steps S1301 to S1305, the job management unit 14 obtains an executed job ID list from the printing apparatus and checks whether the executed job ID list includes an input job ID until receiving the job result of the input job. In step S1302, the job management unit 14 obtains the executed job ID list of jobs being executed from the printing apparatus. In step S1303, the job management unit 14 determines whether the executed job ID list obtained in step S1302 includes an executed job ID of a monitor target job. If the executed job ID of the monitor target job is included (YES in step S1303), the processing advances to step S1304; otherwise (NO in step S1303), the processing advances to step S1306.

In step S1304, the job management unit 14 determines whether an end notification of the target job is sent from the printing apparatus. If the end notification is not received (NO in step S1304), the processing advances to step S1305, and the job management unit 14 continues monitoring the job. If the end notification is received (YES in step S1304), the processing advances to step S1308, and the job management unit 14 records the processing result in the job result of the executed job information 701.

In step S1306, the job management unit 14 inquires of the printing apparatus about the job result. In step S1307, if the job result is obtained as a response to the inquiry in step S1306 (YES in step S1307), the processing advances to step S1308. If the job result is not obtained (NO in step S1307), the processing advances to step S1309.

In step S1309, the job management unit 14 records the job result of the executed job information 701 as “unknown”. This is because, even though the target job is completed, the job management unit 14 cannot receive a response to the inquiry about the job result, from the printing apparatus.

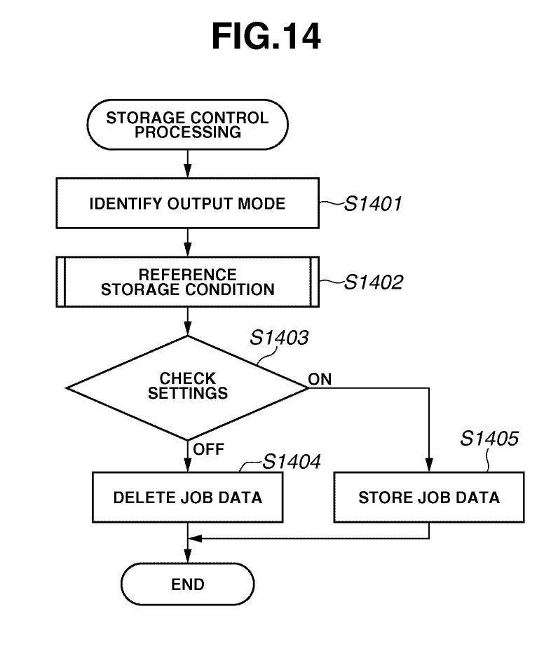

The storage control processing in step S1207 is described in detail with reference to a flowchart of FIG. 14. In step S1401, the storage control unit 15 makes an inquiry to the job data storage unit 13 to identify an output mode of a target job. In step S1402, the storage control unit 15 references the storage conditions. The storage condition reference processing in step S1402 is described below in detail.

In step S1403, the storage control unit 15 checks the setting based on the storage condition settings referenced in step S1402. If the setting is OFF (OFF in step S1403), the processing advances to step S1404, and the storage control unit 15 deletes the job data. If the setting is ON (ON in step S1403), the processing advances to step S1405, and the storage control unit 15 stores the job data.

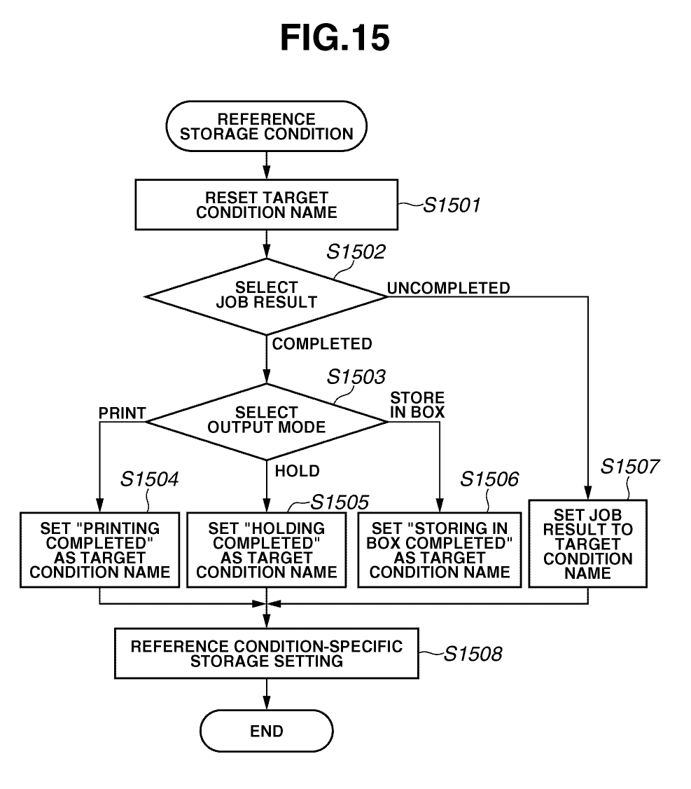

The storage condition reference processing in step S1402 is described in detail with reference to a flowchart of FIG. 15. In step S1501, the storage control unit 15 initializes a target condition name. In step S1502, if the job result is “completed” (COMPLETED in step S1502), the processing advances to step S1503; otherwise (UNCOMPLETED in step S1502), the processing advances to step S1507.

In step S1503, the storage control unit 15 determines an output mode. If the output mode is “print” (PRINT in step S1503), the processing advances to step S1504, and the storage control unit 15 sets “printing completed” to the condition name. If the job result is “hold” (HOLD in step S1503), the processing advances to step S1505, and the storage control unit 15 sets “holding completed”. If the job result is “store in box” (STORE in step S1503), the processing advances to step S1506, and the storage control unit 15 sets “storing in box completed”. In step S1508, the storage control unit 15 references the storage setting of the target condition name.

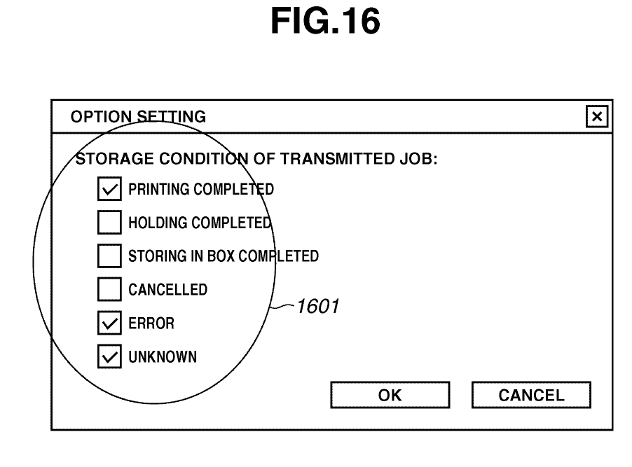

FIG. 16 illustrates an example of a storage condition specifying UI. Referring to FIG. 16, how to specify the condition-specific storage setting information 703 is described. First, a user marks a checkbox (1601) corresponding to each condition. The marked checkbox means that the storage setting is set ON, and the unmarked checkbox means that the storage setting is set OFF.

As described above, job data storage processing can be controlled based on combination of the job result and the output mode. According to the first exemplary embodiment, the job data storage unit stores job data of jobs satisfying conditions for storage set by a user, and deletes job data of the other jobs.

### Second Exemplary Embodiment

In the first exemplary embodiment, whether to store job data or not is determined based on a job result and an output mode. However, some job data may need to be stored depending on job properties (priority, possibility of change, or the like). In this case, storage settings can be specified for each job.

In a second exemplary embodiment, each job has individual storage setting aside from the storage settings predefined under each condition. The job-based storage setting is added to the job execution information 701. If a target job is completed, job-based storage setting is sent together with the job data ID and the job result to the storage control unit 15 requesting the unit 15 to store the job data. If ON/OFF conditions of the condition-specific storage setting and the job-based storage setting are not matched, the storage setting “ON” is preferentially used.

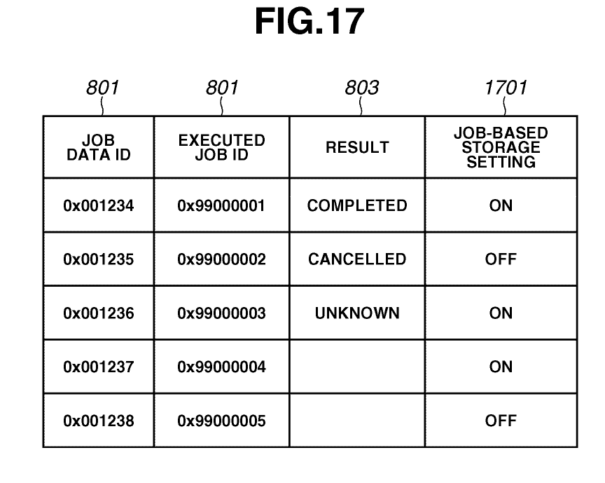

FIG. 17 illustrates an example of the job execution information 701 of the second exemplary embodiment. In addition to the job execution information 701 of the first exemplary embodiment, the information includes a job-based storage setting 1701. The job-based storage setting 1701 specifies whether to store or delete each job. If the job-based storage setting 1701 is ON, the job data storage unit stores the job data. If the setting is OFF, the storage control unit performs processing based on the condition-specific storage setting.

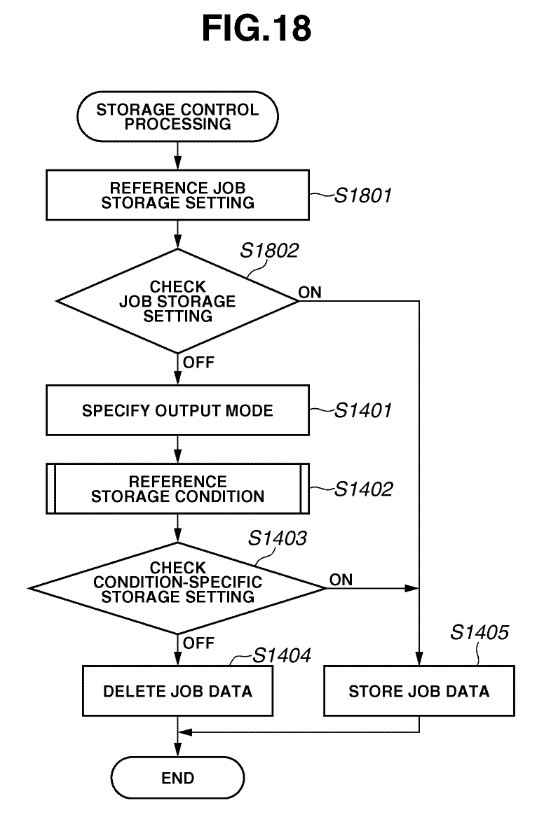

The storage control processing in step S1207 in the second exemplary embodiment of the present invention is described with reference to a flowchart of FIG. 18. The storage control processing in step S1207 in the second exemplary embodiment is almost similar to the first exemplary embodiment except for some steps. That is, the storage control processing in step S1207 in the second exemplary embodiment involves steps S1801 and S1802 in addition to the storage control processing in step S1207 in the first exemplary embodiment.

In step S1801, the storage control unit 15 inquires of the job management unit 14 about the job-based storage setting 1607 of a target job. The job management unit 14 sends back the job-based storage setting 1701 of the job execution information 701 of the target job.

In step S1802, the storage control unit 15 performs processing based on the job-based storage setting 1701 obtained in step S1801. If the setting is OFF (OFF in step S1802), the processing advances to step S1401, and the storage control unit 15 performs processing based on the storage condition. If the setting is ON (ON in step S1802), the processing advances to step S1405, and the job data storage unit 13 stores the job data.

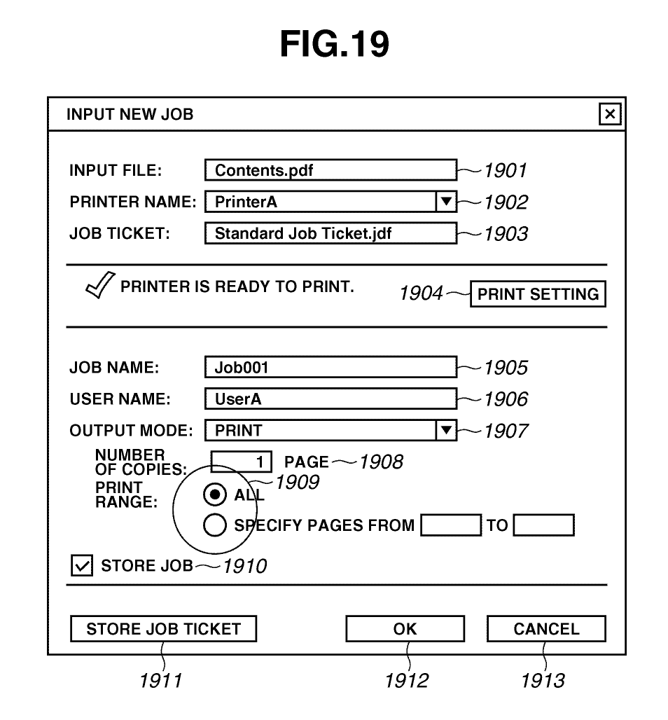

FIG. 19 illustrates an example of a new job input screen of the second exemplary embodiment. A user can set the job-based storage setting 1701 with the new job input screen. The new job input screen is described with reference to FIG. 19. The input file is specified using an edit box 1901. A printer as a destination of the input job is specified using a combo box 1902. The combo box 1902 lists names of registered printers. A job ticket is specified using an edit box 1903.

When a print setting button 1904 is clicked, a UI for detailed print settings is displayed. A job name and a user name are set with any character string in an edit box 1905 and an edit box 1906, respectively. The output mode is selected from “print”, “hold”, and “store in box” in a combo box 1907.

As for the number of copies, an arbitrary integral number is input to an edit box 1908. A print range is selected from “all” or “specify pages” with a radio button 1909. The job-based storage setting is specified with a checkbox 1910. If the checkbox is marked, the job-based storage setting is ON; otherwise, the job-based storage setting is OFF.

When a “store job ticket” button 1911 is clicked, an edited job ticket is stored. When an OK button 1912 is clicked, a job is input to the printing apparatus. When a cancel button 1913 is clicked, the screen is closed without inputting a job.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-119030 filed Apr. 27, 2007, which is hereby incorporated by reference herein in its entirety.

What is claimed is:

1. An information processing apparatus capable of storing a job transmitted to a printing apparatus, comprising:
an obtaining unit configured to obtain a job result regarding the job from the printing apparatus;
an identifying unit configured to identify an output mode of the job;
a reference unit configured to store a storage setting that defines whether to store or delete job data based on a combination of the job output mode and the job result, and reference the storage setting based on the output mode identified by the identifying unit and the job result obtained by the obtaining unit; and
a storage control unit configured to store or delete the transmitted job based on the storage setting referenced by the reference unit.

2. The information processing apparatus according to claim 1, further comprising:
a specifying unit configured to specify a storage setting on a job-by-job basis,
wherein if the job-based storage setting specifies to store the job data, the storage control unit stores the job data, and if the job-based storage setting specifies not to store job data, the storage control unit stores or deletes the job data based on the storage setting referenced by the reference unit.

3. A method for an information processing apparatus capable of storing a job transmitted to a printing apparatus, comprising:
transmitting a job to the printing apparatus;
obtaining a job result regarding the job from the printing apparatus;
identifying an output mode of the job;
referencing a storage setting that defines whether to store or delete job data based on a combination of the job output mode and the job result; and
storing or deleting the transmitted job based on the referenced storage setting.

4. The method according to claim 3, further comprising:
specifying a storage setting on a job-by-job basis,
storing the job data if the job-based storage setting specifies to store the job data, and storing or deleting the job data if the job-based storage setting specifies not to store the job data based on the referenced storage setting.

5. A storage medium storing a program that causes a computer to execute a method for an information processing apparatus capable of storing a job transmitted to a printing apparatus, the method comprising:
transmitting a job to the printing apparatus;
obtaining a job result regarding the job from the printing apparatus;
identifying an output mode of the job;
referencing a storage setting that defines whether to store or delete job data based on a combination of the job output mode and the job result; and
storing or deleting the transmitted job based on the referenced storage setting.
